(19) United States
(12) Patent Application Publication
(10) Pub. No.: US 2010/0282528 A1
(43) Pub. Date: Nov. 11, 2010

(54) Electro-Mechanical Battery

(76) Inventor: Yoram Palti, Haifa (IL)

Correspondence Address: PROSKAUER ROSE LLP, ONE INTERNATIONAL PLACE, BOSTON, MA, 02110, US

(21) Appl. No.: 12/774,200

(22) Filed: May 5, 2010

Related U.S. Application Data
(60) Provisional application No. 61/175,568, filed on May 5, 2009.

(51) Int. Cl. B60L 11/16; B60K 1/04; H02K 7/02; H01R 39/30; H02K 7/09; H02K 5/26

(52) U.S. Cl. 180/65.1; 322/4; 310/219; 310/90.5; 310/418

(57) ABSTRACT

An electro-mechanical battery includes a support member. The electro-mechanical battery also includes a first rotating frame. The first rotating frame is supported by the support member and configured to rotate about an axis. The electro-mechanical battery also includes at least one battery, which is supported by the first rotating frame. A mechanical coupling system is configured to store rotational kinetic energy in the first rotating frame and facilitate retrieval of the rotational kinetic energy. The electro-mechanical battery also includes a rotating electrical connection between the support member and the at least one battery. The rotating electrical connection is configured to permit charging of the at least one battery and discharging of the at least one battery while the first rotating frame is rotating.

### RELATED APPLICATIONS

This application claims the benefit of U.S. Provisional Application Ser. No. 61/175,568, entitled “Electro Mechanical Battery (EMB),” filed on May 5, 2009. The entire disclosure of U.S. Provisional Application Ser. No. 61/175,568 is incorporated herein by reference.

### TECHNICAL FIELD

The invention relates to an electro-mechanical battery. In particular, the invention relates to an electro-mechanical battery for use in powering a vehicle.

### BACKGROUND

It is generally believed that gas emissions are responsible for global warming. The fear of atmospheric pollution and global warming serves as a strong inducer to replace the conventional combustion engine transportation vehicles with electric driven ones to reduce greenhouse gas emissions. Many governments have issued regulations that require the automotive industry to reduce the total harmful emissions from vehicles. Several different types of alternative fuel vehicles exist that serve to reduce harmful emissions from vehicles, for example, electric, hybrid electric, or solar powered vehicles. Current versions of electric cars are generally powered by on-board battery packs. Rechargable batteries are generally used, for example, lead-acid, NiCd, nickel metal hydride, lithium ion, Li-ion polymer, zinc-air, and molten salt batteries.

However, currently available batteries pose major limitations on the functionality of electric cars. Currently available batteries have a relatively small energy storage capacity that limits the driving range. This is critical because recharging a battery on the road is impractical because battery charging takes several hours. In addition, batteries are heavy. The weight and volume of the batteries affect the vehicle's overall energy expenditure, range, stability, and roadability. Moreover, batteries with both high energy capacity and high power are expensive, therefore, the occasional need for high power bursts is difficult to satisfy.

Another potential source of clean energy that can serve to drive cars and other vehicles is the flywheel. A flywheel is a mechanical device with significant moment of inertia so that it can be used as a storage device for rotary energy. The larger the wheel weight, radius and speed of rotation, the higher the storage capacity. The energy storage capacity of flywheels is impressive. For example, a traditional lead-acid cell—the battery most often used in heavy-duty power applications—stores energy at a density of 30-40 watt-hours per kilogram. A flywheel-based battery can reach energy densities 3-4 times higher, at around 100-130 watt-hours per kilogram. Unlike the battery, the flywheel can also store and discharge energy rapidly without being damaged, meaning it can charge up to full capacity within minutes instead of hours and deliver, when needed, up to one hundred times more power than a conventional battery. What's more, it's unaffected by extreme temperatures, boasts an efficiency of 85-95%, and has a lifespan measured in decades rather than years.

Flywheels have additional properties that may affect their performance in a vehicle as they resist changes in their rotational speed, which helps steady the rotation of the shaft when a fluctuating torque is exerted on it by its power source such as a piston-based, or when the load placed on it is intermittent. They also resist changes in the orientation of the rotation axis, i.e., the gyro effect. This may improve the stability of a vehicle on the road; however it may affect its maneuverability. Thus, recently, flywheels have become the subject of extensive research as power storage devices for uses in vehicles.

### SUMMARY

One aspect of the invention relates to an electro-mechanical battery. The electro-mechanical battery can include a support member. A first rotating frame can be supported by the support member. The first rotating frame can be configured to rotate about an axis. The electro-mechanical battery can also include at least one battery that is supported by the first rotating frame. A mechanical coupling system can be configured to store rotational kinetic energy in the first rotating frame. The mechanical coupling system can also facilitate retrieval of the rotational kinetic energy. The electro-mechanical battery can also include a rotating electrical connection between the support member and the at least one battery. The rotating electrical connection is configured to permit charging of the at least one battery and discharging of the at least one battery while the first rotating frame is rotating.

In some embodiments, the rotating electrical connection includes a mercury revolving contact.

In some embodiments, the electro-mechanical battery includes a second rotating frame. The second rotating frame can be supported by the support member and can be configured to rotate about the axis. In one embodiment, the first rotating frame is configured to rotate in a first direction and the second rotating frame is configured to rotate in a second direction. The second direction may be opposite to the first direction.

In some embodiments, the first rotating frame is supported by the support member by at least one of a magnetic bearing or a high-temperature superconductor bearing.

In other embodiments, the support member is supported by at least one gimbal.

In some embodiments, the electro-mechanical battery includes a housing. The housing can be configured to keep the first rotating frame and the at least one battery in a vacuum or a partial vacuum.

In some embodiments, a total mass of the first rotating frame and the at least one battery is at least 100 kilograms. In some embodiments the first rotating frame is designed to rotate at least 8,000 RPM, while in other embodiments the first rotating frame is designed to rotate at least 20,000 RPM.

Another aspect of the invention relates to an electro-mechanical battery that includes a flywheel. The flywheel includes a first rotating frame. The flywheel can be configured to store rotational kinetic energy in the first rotating frame and facilitate retrieval of the rotational kinetic energy. The first rotating frame can have at least one receptacle. The electro-mechanical battery can also include at least one battery disposed within the at least one receptacle. The electro-mechanical battery includes a rotating electrical connection configured to permit charging of the at least one battery while the first rotating frame is rotating and to permit discharging of the at least one battery while the first rotating frame is rotating.

In some embodiments the electro-mechanical battery includes a housing configured to keep the flywheel in a vacuum or a partial vacuum.

In some embodiments, the electro-mechanical battery includes a second flywheel that has a second rotating frame. The first rotating frame can be configured to rotate in a first direction and the second rotating frame can be configured to rotate in a second direction. The second direction may be opposite the first direction.

In some embodiments, a total mass of the fly wheel and the at least one battery is at least 100 kilograms. In some embodiments the rotating electrical connection comprises a mercury revolving contact.

Another aspect of the invention relates to a vehicle. The vehicle includes a chassis. The vehicle can also include at least two wheels configured with respect to the chassis so that the chassis rides on the at least two wheels. The vehicle also includes an electro-mechanical battery positioned in the vehicle. The electro-mechanical battery can include a flywheel having a first rotating frame. The flywheel can be configured to store a rotational kinetic energy in the first rotating frame and facilitate retrieval of the rotational kinetic energy. The rotating frame can include at least one receptacle. The flywheel can also include at least one battery disposed within the at least one receptacle. The flywheel can include a rotating electrical connection configured to permit charging of the at least one battery while the first rotating frame is rotating and to permit discharging of the at least one battery while the first rotating frame is rotating. The vehicle can be configured so that rotational kinetic energy of the first rotating frame can be used to drive the vehicle and that electrical energy from the at least one battery can be used to drive the vehicle.

Deceleration of the vehicle may be accomplished at least in part by transferring kinetic energy of the vehicle into rotational kinetic energy of the first rotating frame. Deceleration of the vehicle may also be accomplished at least in part by transferring kinetic energy of the vehicle into electricity, and using said electricity to charge the battery.

### BRIEF DESCRIPTION OF THE DRAWINGS

FIG. 1A is a side view of a wheel unit of an electro-mechanical battery, according to one embodiment of the present invention.

FIG. 1B is an exploded detail view of a portion of FIG. 1A.

FIG. 2A is a schematic illustration of an embodiment of the invention, depicting a wheel unit coupled to a frame and a mechanical coupling system.

FIG. 2B is a schematic illustration of an embodiment of the invention, depicting multiple rotating wheel units.

FIG. 3A is a schematic illustration of an embodiment of the invention, depicting two flywheels with a horizontal rotational axis.

FIG. 3B is a schematic illustration of an embodiment of the invention, depicting a flywheel located in the center of a vehicle with a vertical rotational axis.

FIG. 3C is a side view of an embodiment of the invention, depicting a flywheel located in the rear front of a vehicle.

FIG. 3D is a side view of an embodiment of the invention, depicting a flywheel located in the center of a vehicle with a horizontal rotational axis.

FIG. 3E is a side view of an embodiment of the invention, depicting two flywheels with different rotational axes.

FIG. 4 is a schematic illustration of an embodiment of the invention, depicting a flywheel horizontally oriented in a vehicle by a gimbal.

FIG. 5 is a schematic illustration of an embodiment of the invention, depicting a flywheel vertically oriented in a vehicle by a gimbal.

FIG. 6 is a schematic illustration of an embodiment of the invention, depicting a rotational axis of an electro-mechanical battery vertically oriented in a vehicle.

FIG. 7 is a schematic illustration of an embodiment of the invention, depicting two wheel units rotating in opposite directions.

FIG. 8A is a front view of a charging station that may be used for certain embodiments of the invention.

FIG. 8B is a front view of a charging station that may be used for certain embodiments of the invention.

FIG. 8C is a side view of a charging station that may be used for certain embodiments of the invention.

FIG. 9 is a side view of a stand alone charging unit that may be used for certain embodiments of the invention.

FIG. 10A is a schematic illustration of an embodiment of the invention, depicting a square-shaped mechanical connector and mechanical receptor used in a charging station.

FIG. 10B is a schematic illustration of an embodiment of the invention, depicting a cross-shaped mechanical connector and mechanical receptor used in a charging station.

FIG. 10C is a schematic illustration of an embodiment of the invention, depicting a coupling clutch and gears used in a charging station.

FIG. 11 is a schematic illustration of an embodiment of the invention, depicting an electro-mechanical battery with a housing.

### DETAILED DESCRIPTION OF THE PREFERRED EMBODIMENTS

The electro-mechanical (EMB) embodiments described below integrate two power sources, electric batteries and a flywheel or other rotating mass, with a single engine. The EMB can turn the dead weight of traditional electric batteries into a power source. Therefore, what used to be a hindrance in electric cars can be used to obtain benefits.

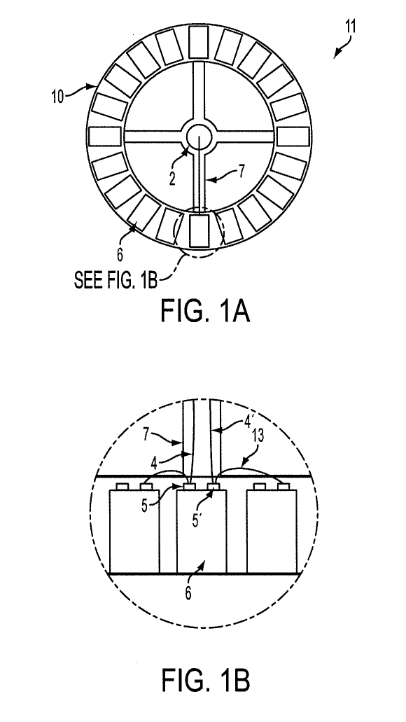

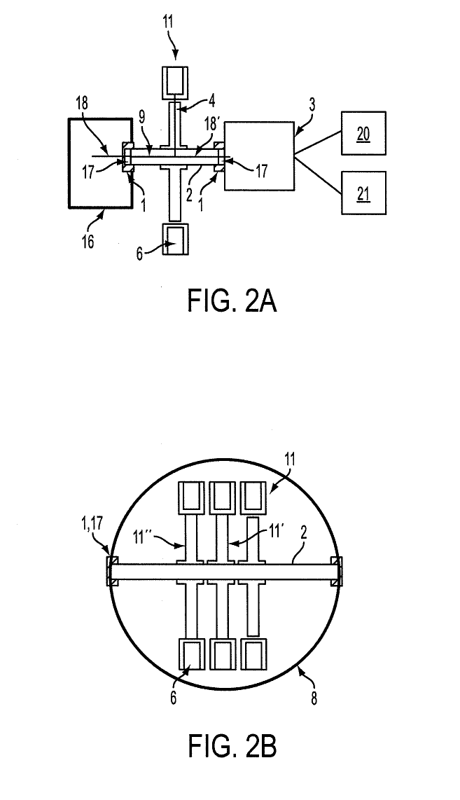

FIG. 1A is a side view of a wheel unit 11 of an electro-mechanical battery, according to one embodiment of the present invention. This embodiment is an electro-mechanical battery that contains at least one wheel unit 11. In other embodiments, the electro-mechanical battery contains more than one wheel unit, for example, wheel units 11, 11′, 11″ of FIG. 2B. In one embodiment the wheel unit 11 is a flywheel. Each wheel unit 11 consists of a first rotating frame 10 that can support at least one battery 6. In some embodiments, the first rotating frame 10 is cylindrical. The first rotating frame 10 can be at the periphery of the electro-mechanical battery. In some embodiments, the first rotating frame 10 can support a large number of batteries, for example, between 4 and 32 batteries per frame. The batteries can be rechargeable. In some embodiments the batteries 6 are arranged symmetrically on the periphery of the wheel unit 11.

In some embodiments, the first rotating frame 10 is designed to rotate at least about 8,000 RPM. In other embodiments, the first rotating frame 10 is designed to rotate at least about 20,000 RPM.

The wheel unit 11 is supported by a support member, for example, the support member can be the stationary side of the bearings 1 (FIG. 2A), which is preferably mounted to the chassis of a vehicle, for example the chassis 101 of FIGS. 4-6. The support member is preferably substantially stationary with respect to the chassis of the vehicle, and it may be mounted either directly of indirectly to the chassis of a vehicle. Examples of indirect mounting would include using shock absorbers, springs, or other intervening components placed between the support member and the chassis. The support member supports the first rotating frame 10. The first rotating frame 10 is configured to rotate about an axis 2 using, for example, a wheel and axle configuration. In some embodiments the axle 2 includes at least one spoke 7 between the axle 2 and the first rotating frame 10.

FIG. 1B is an exploded detail view of a portion of the wheel unit shown in FIG. 1A. Each battery 6 can have at least two terminals 5, 5′ to which at least two leads 4, 4′ are connected. In some embodiments, the leads 4, 4′ run to the support member 2 along at least one of the spokes 7. In some embodiments, the support member 2 and the spokes 7 are hollow or have an aperture to accommodate the leads 4, 4′.

The terminals 5, 5′ of the batteries 6 are interconnected by interconnector leads 13. The interconnector leads 13 can be in parallel or in series to provide the desired voltages and current capacities. The power, at the appropriate voltages, thus reaches the electric motors and other vehicle units or visa versa to charge or discharge the batteries.

FIG. 2A is a schematic illustration of an embodiment of the invention, depicting a wheel unit 11 coupled to a frame 16 and a mechanical coupling system 3. FIG. 2B is a schematic illustration of an embodiment of the invention, depicting multiple rotating wheel units 11, 11′, 11″. Referring to FIG. 2A, the support member, for example, the stationary portion of the bearings 1, can be held in position by being attached to a frame 16. In one embodiment, the frame 16 is the frame or chassis of a vehicle. In some embodiments, the support member can be held in position by being attached to a body or other support mechanism, for example, body 8 of FIG. 2B. In one embodiment, body 8 is a gimbal. The axle 2 can be held in position by at least one bearing 1. In some embodiments, the bearing 1 is mounted directly on the axle 2. The bearing 1 can enable the wheel unit 11 and the axle 2 to rotate relative to the car frame 16 or the body 8.

When the electro-mechanical battery is used to power a vehicle, the frame 8 of FIG. 2B can be a part of the vehicle frame or be the frame of a device such as a gyroscope or gyro-like system attached to the vehicle frame. The gyroscope or gyro-like system allows the support member and the axle 2 to change orientation in space relative to the vehicle body while rotating and at the same time maintain the electric contacts.

In some embodiments, the bearing 1 is a magnetic bearing. A magnetic bearing may be preferred in some embodiments, as opposed to conventional mechanical bearings, because friction is directly proportional to speed, and at the necessary speeds, too much energy may be lost to friction if conventional mechanical bearings are used. In some embodiments, the magnetic bearings are based on permanent magnets plus computer controlled electromagnets.

In other embodiments, high-temperature superconductor (“HTSC”) bearings are used. HTSC bearings can, for example, extend the amount of time energy can be stored economically. In one embodiment, hybrid bearing systems are used. Hybrid bearings can include permanent magnets that support the load and HTSC bearings that stabilize the load.

Flywheels equipped with conventional steel bearings may reach rotation speeds of about 30,000 to about 50,000 RPM (rim speeds of over 1,000 m/s). Conventional steel bearings have exceeded 60,000 RPM when they have been placed inside evacuated, or vacuum, chambers. In contrast, flywheels equipped with magnetic bearings have virtually unlimited rotation speed, for example, 1,000,000 RPM.

The bearings 1 can enable a constant effective electric contact by using, for example, at least one rotating electrical contact 17. In some embodiments, the rotating electrical connection 17 is between the support member and the at least one battery. The rotating electrical connection 17 can be configured to permit charging of the at least one battery via at least two electrical terminals, for example the leads 18 and discharging of the at least one battery via the at least two electrical terminals 18.

The rotating electrical contact 17 can also facilitate contact between the central wires 9 and the corresponding electric leads 18 in the frame 8 or in the mechanical coupling system 3. In some embodiments, the rotating electrical contact 17 can be, for example, a mercury revolving contact. The rotating electrical contact 17 can have a rotating part and a stationary part, for example, the stationary part can be the support member. The stationary part of the rotating electrical contact 17 can connect to the central wires 9 that convey electric current to, for example, a car motor.

In some embodiments, the leads 4, 4′ run from the terminals 5 of the battery 6 along at least one of the spokes 7. The leads 4, 4′ then make contact with the central wires 9 that run along the axle 2.

In some embodiments, one end of the axel 2 is connected, mechanically and electrically, directly or indirectly, to the flywheel mechanical coupling system 3. The flywheel mechanical coupling system 3 can deliver or receive, i.e. exchange as desired, the rotating mechanical power between the wheel unit 11 and either an electrical generator (for example a dynamo) 21 mounted on the vehicle, or to the appropriate mechanical connector in an external charging station 20. The electrical generator 21 can, for example, charge the wheel unit batteries, other batteries, or provide power to the vehicle motors.

Optionally, transfer of electric power to a rotating flywheel from a stationary entity, or visa versa, can be by inductive means, for example, using coupled coils. Preferably, opposite coiling can be used to zero out the interfering mechanical forces that may be generated. Another option is to control the different energy fluxes in order to optimize performance. Charging with and orienting coupled coils is conventional and known to those of ordinary skill in the art.

Implementing a flywheel mechanical coupling system, for example the mechanical coupling system 3 of FIG. 2A, is conventional and known to those of ordinary skill in the art. In addition, systems for exchanging energy and converting the motion of a flywheel to power a vehicle is conventional and known to those of ordinary skill in the art.

In one embodiment, the wheel unit or flywheel assembly can be fixed directly to the vehicle body or chassis (101 of FIGS. 4, 5, and 6) using bearings, as described above. Under such conditions the forces generated by the wheel unit or flywheel rotation may affect the maneuverability of the vehicle. The reason for this is that when used in vehicles, flywheels also act as gyroscopes, since their angular momentum is typically of a similar order of magnitude as the forces acting on the moving vehicle. This gyro effect can be prevented by using a pair of similar flywheels rotating in opposite directions at the same speed. FIG. 7 is a schematic illustration of an embodiment of the invention, depicting two wheel units 72, 74 rotating in opposite directions. A first wheel unit 72 having a first rotating frame and a second wheel unit 74 having a second rotating frame are connected to a gimbal 60 and rotate about the axle 2. To prevent the gyro effect discussed above, the first wheel unit 72 rotates in a first direction 76 while the second wheel unit 74 rotates in a second direction 78 that is opposite to the first direction 76 of the first wheel unit 71. Optionally, the freedom of movement of the gimbal can be controlled to minimize the gyro effects.

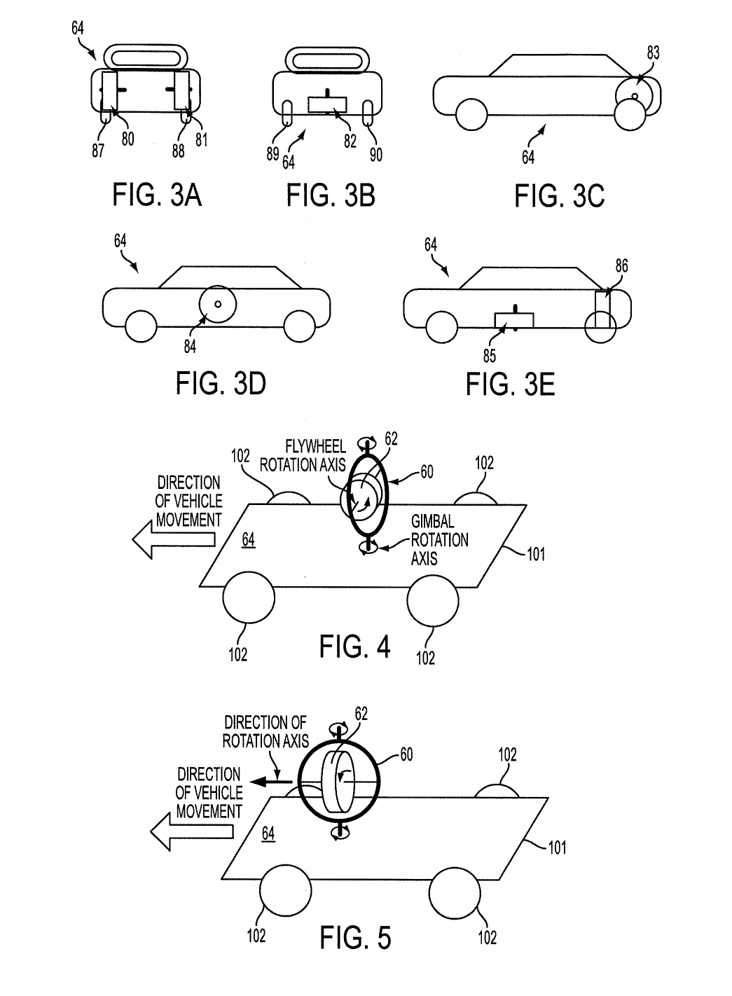

Alternatively, the wheel unit or flywheel can be fixed indirectly to a vehicle body or chassis by using at least one gimbal to couple the wheel unit to the vehicle frame. FIG. 4 is a schematic illustration of such an embodiment of the invention, depicting a flywheel 62 horizontally oriented in a vehicle 64 by a gimbal 60. FIG. 5 is a schematic illustration of an embodiment of the invention, depicting a flywheel 62 vertically oriented in a vehicle 64 by a gimbal 60. A gimbal 60 is a pivoted support that allows the rotation of an object about a single axis. A set of two gimbals, one mounted on the other with pivot axes orthogonal, as used in gyroscopes, may be used to allow a flywheel when mounted on the innermost gimbal to remain immobile regardless of the motion of its support. Under such conditions the rotating wheel unit or flywheel will not affect the maneuverability of the vehicle 64. Alternatively the wheel unit or flywheel can be mounted on a single gimbal, or a pair of gimbals. The freedom of movement of one or both of the gimbals can be restricted mechanically or electromagnetically. Under these circumstances one can control of the orientation of the wheel unit or flywheel rotation axis to the desired one so as to add to the stabilization of the vehicle with respect to undesired movements or changes in orientation. For example, when the rotation axis is fixed in a horizontal orientation that is normal to the vehicle movement direction (see, for example FIGS. 3A, 3C, 3D, 4) the rotation forces will resist sideways rotation. This makes rocking sideways or rolling over during sharp turns difficult. A rotation force that resists sideways rotation also makes it more difficult to turn right or left. Thus, these conditions add to the vehicle stabilization at the price of making it more difficult to turn the vehicles sideways on the road. However, this difficulty can be overcome by the vehicle steering system.

FIGS. 3A-3E depict varying locations of a flywheel, wheel unit, or electro-mechanical battery within a vehicle 64. When the flywheel exhibits gyro type behavior, it may affect the vehicles roadability, both positively and negatively, depending on the orientation. The main potential positive effect is stabilization. The flywheel can be an effective shock absorber for road bumps and can prevent a vehicle from turning over. The main potential negative effect is interference with turning at curbs and interference with entering slopes, for example, driving a vehicle up or down a hill. The actual effects depend upon the orientation of the flywheel rotational axis.

For example, FIG. 3A is a schematic illustration of an embodiment of the invention, depicting two flywheels 80, 81 with a horizontal rotational axis. Each flywheel 80, 81 is located above a wheel, 87, 88. The two flywheels 80, 81 can be located in either the front or rear of the vehicle 64. The rotation axis is fixed in a horizontal orientation that is normal to the vehicle movement direction. When the flywheels are placed in this type of configuration, with opposing rotations of the flywheels, the effects of driving a car up or down, or left or right, are neutralized.

FIG. 3B is a schematic illustration of an embodiment of the invention, depicting a flywheel 82 located in the center of a vehicle with a vertical rotational axis. The flywheel is located between two wheels 89, 90. The flywheel 82 can be located at either the front center or the rear center of the vehicle 64. Placing a flywheel in this type of configuration does not effect a vehicle that is moving left or right. However, in this configuration, the vehicle will resist driving up or down hills, road bumps, and turning over. The resistance to slopes or hills can be overcome with controlled gimbals that allow a movement of about 10 to 20 degrees only when encountering rapid transients such as those induced by bumps, while limiting movement in response to slow angle changes.

FIG. 3C is a side view of an embodiment of the invention, depicting a flywheel 83 located in the rear front of a vehicle. The rotation axis is fixed in a horizontal orientation that is normal to the vehicle movement direction. Placing a flywheel in this type of configuration has no effect on the ability of the vehicle to drive up or down slopes or hills. However, this configuration resists turning left and right.

FIG. 3D is a side view of an embodiment of the invention, depicting a flywheel 84 located in the center of a vehicle with a horizontal rotational axis. The rotation axis is fixed in a horizontal orientation that is normal to the vehicle movement direction. Placing a flywheel in this type of configuration has similar effects to those described above in connection with FIG. 3A.

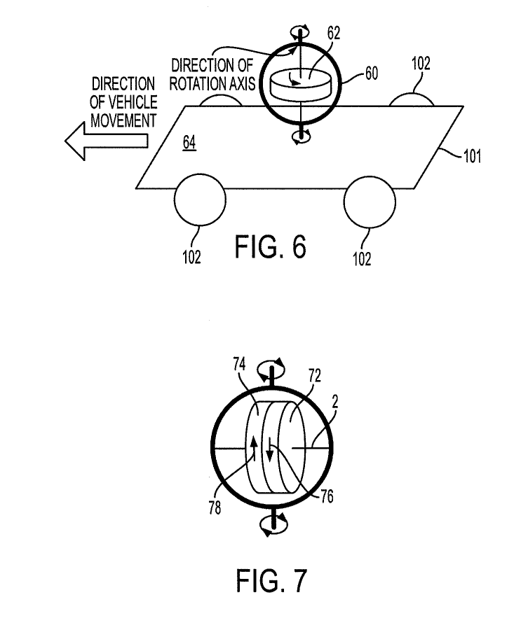

FIG. 3E is a side view of an embodiment of the invention, depicting two flywheels 85, 86 with different rotational axes. Flywheel 85 is located at the center of the vehicle 64. Flywheel 86 is located at the rear of the vehicle 64. Alternatively, flywheel 86 could be located at the front of the vehicle 64. This embodiment can damp undesired up and down movement of the front or back of the vehicle, when riding on bumps. Here the flywheel axis of rotation is vertical as illustrated in FIGS. 5 and 6. Obviously a vehicle can be equipped with flywheels of more than one orientation (see FIGS. 3A-E for examples of different flywheel arrangements) or freedom of movement.

A major advantage of a vehicle equipped with the embodiments described herein is that it is powered by two separate sources of energy; batteries and flywheels. The total electric energy that can be made available from these sources is a function of the following: the power of each battery, the number of batteries in each wheel unit and the number of wheel units incorporated in the device. These sources may also be combined with other energy sources such as a conventional motor.

The rotary mechanical energy that is conveyed from the flywheel to the vehicle via the axis or support member of the flywheel is a function of a number of factors such as the weight of the wheel units and its distribution around the central axis. For example, the total mass of the first rotating frame and the at least one battery can be at least 100 kilograms. The weight of the batteries, are typically “dead weight” which hampers the performance of the standard electric car. It is typical in the design of electric cars to try to minimize this deadweight. However, in the electro-mechanical batteries described herein, the weight of the batteries is used as a source of energy.

Other factors in the conveyance of rotary mechanical energy from the flywheel to the vehicle include the diameter of the flywheel and the speed of the flywheel rotation. The power capacity of flywheels can be enormous. Table 1 lists some examples of the capacity of some typical flywheels.

TABLE 1

| | k (varies | Mass | | Angular | Energy | Energy |
|---|---|---|---|---|---|---|
| Object | with shape) | (kg) | Diameter | Velocity (rpm) | stored (J) | stored (kWh) |
| bicycle wheel | 1 | 1 | 700 mm | 150 | 15 | 0.4 × 10⁻⁶ |
| bicycle wheel - | 1 | 1 | 700 mm | 300 | 60 | 1.6 × 10⁻⁶ |
| double speed | | | | | | |
| bicycle wheel - | 1 | 2 | 700 mm | 150 | 30 | 0.8 × 10⁻⁶ |
| double mass | | | | | | |
| concrete car wheel | 1/2 | 245 | 500 mm | 200 | 1.68 | 0.47 × 10⁻³ |
| wheel on a train at | 1/2 | 942 | 1 m | 318 | 65 | 18 × 10⁻³ |
| 60 km/h | | | | | | |
| giant dump truck | 1/2 | 1000 | 2 m | 79 | 17 | 4.8 × 10⁻³ |
| wheel at 18 mph | | | | | | |
| small flywheel | 1/2 | 100 | 600 mm | 20000 | 9.8 | 2.7 |
| battery | | | | | | |
| regenerative | 1/2 | 3000 | 500 mm | 8000 | 33 | 9.1 |
| braking flywheel | | | | | | |
| for trains | | | | | | |
| electrical power | 1/2 | 600 | 500 mm | 30000 | 92 | 26 |
| backup flywheel | | | | | | |

Energy is stored in the rotor as kinetic energy, or more specifically, rotational energy.

$${E}_{k} = \frac{1}{2} \cdot I \cdot {ω}^{2} \qquad EQN . 1$$

where ω is the angular velocity, and I is the moment of inertia of the mass about the center of rotation.

The moment of inertia for a solid cylinder is:

$${I}_{z} = \frac{1}{2} {mr}^{2} \qquad EQN . 2$$

The moment of inertia for a thin-walled cylinder is:

I=mr² EQN. 3

The moment of inertia for a thick-walled cylinder is:

$$I = \frac{1}{2} m ( {r}_{1}^{2} + {r}_{2}^{2} ) \qquad EQN . 4$$

where m denotes mass and r denotes a radius. When calculating with SI units, the standards would be for mass, kilograms; for radius meters; and for angular velocity, radians per second. The resulting answer would be in Joules.

The amount of energy that can safely be stored in the rotor depends on the point at which the rotor will warp or shatter. The hoop stress on the rotor is a major consideration in the design of a flywheel energy storage system.

σₜ=ρr²ω² EQN. 5

where σₜ is the tensile stress on the rim of the cylinder, ρ is the density of the cylinder, r is the radius of the cylinder, and ω is the angular velocity of the cylinder.

These equations, EQNS. 1-5, can be used to do rough calculations and find the rotational energy stored in various flywheels. I=kmr², and k is from a list of moments of inertia.

A vehicle equipped by a combination of these specific two power sources, i.e., electrical power and mechanical power, can provide a number of important advantages over conventional electric and hybrid (combustion plus electric motors) vehicles. For example, flywheels can store huge amount of energy on top of that of the regular electric battery power. Flywheels can output power at extremely high rates thus overcoming a major limitation of cars powered by batteries that cannot output power at extremely high rates. Flywheels can be charged at extremely high rates thus overcoming a major limitation of cars powered by batteries. For example, cars powered by batteries typically can take several hours to charge while vehicles powered by flywheels can take only minutes to charge. In addition, flywheels provide a very stable flux of energy even when the primary energy source in unstable or intermitted, such as a piston engine. Flywheels can also serve to stabilize a vehicle, as discussed above with reference to FIG. 3E. The amount of remaining available power can be determined with a high degree of accuracy based on measuring the rotation speed. The flywheel battery can be charged by a variety of elements: an electric power source, a rotating mechanical system and the engine of a hybrid car. The rotation can provide a burst of very high energy in contrast to standard electric batteries which cannot provide a high burst of energy or acceleration. Therefore simpler and cheaper batteries, that can not output the large transient power required for starting motion or emergency acceleration, can be used in combination with the energy that the flywheel provides. When required the flywheel batteries can be charged by a dynamo activated by the rotating wheel. When rapid charging is required, this can be done mechanically and after that the batteries can be charged at an appropriate slower rate by a dynamo activated by the rotating wheel.

The electro-mechanical battery described above can have many different uses. For example, the electro-mechanical battery can be used in a car. To use the electro-mechanical battery in a car, the user may charge both components (mechanical and electric) of the electro-mechanical battery system in a charging station. If charging is required away from a charging station, for example at home, or in a parking lot, an electric outlet may be used to charge the batteries of the EMB.

Optionally, before starting the trip the driver feeds the car computer or controller with the necessary data, unless he prefers to use the default setting. The inputted data can include, for example, the expected length of the trip (distance), stops, the desired charging station and its distance, traffic condition, optimal driving speed, nature of the terrain, etc. Some of the data can be fed from a navigation (GPS) system. As the driver begins to drive the car, a controller, with appropriate logic capacity draws all or a fraction of the required power from either one or both sources so as to optimize the ride under the given conditions. The controller may also swap energy between the sources. The logic used may be, in part similar to the one used in hybrid cars. Down hill driving and braking can be utilized for charging. Manual overriding may also be implemented to allow the driver to select a power source. As the mechanical energy is dissipating slowly (due to friction) while the electric energy is maintained, it is generally preferable to first use the mechanical source. However, it is preferable to save some of the mechanical energy for the supply of spikes of high energy when needed and as estimated to be needed. Alternatively, in the case that the ride is expected to encounter at a late stage a road where vehicle stability is an issue, the system may be programmed to preserve the flywheel energy (which also provides stability) till that segment is reached. The driver may also select a specific mode of stabilization as deems needed, i.e. position the rotation axis at the appropriate orientation and with the necessary degrees of freedom. This action can also be activated automatically using appropriate mechanical sensors.

When desired or necessary, the car can be brought to a charging station, which is equivalent to or even part of a gas filling station. In the station the EMB is either charged or replaced with a pre-charged EMB.

In addition to cars, the electro-mechanical battery can also be used in trains or trams. The operator of the vehicles goes through many of the same motions as the car driver does. One significant difference between a car and train or tram is that such trains or trams usually have stops at fixed locations where they can rapidly charge the mechanical battery without wasting time. The energy can then be slowly transferred to the electric battery while the vehicle is driving.

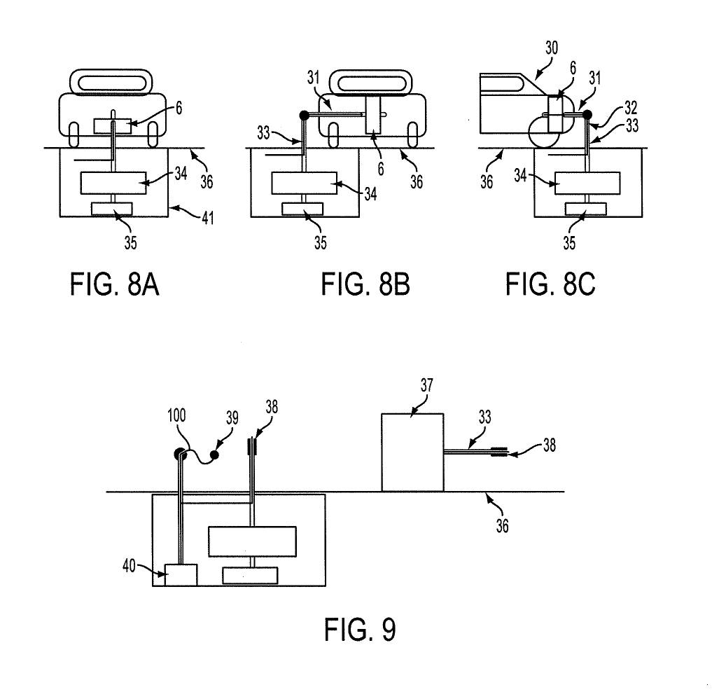

Since the total power that the EMB units provide is limited, normal use of the vehicle requires recharging of the system or replacing the EMB with a fully charged EMB. Charging or replacing the EMB can occur, for example, at charging stations. FIGS. 8A, 8B, and 8C are views of three possible configurations for charging stations. The charging stations are preferably designed to charge (or replace) both the mechanical system by bringing its speed of rotation to the required levels, and the batteries by feeding them electric current from, for example, an electric generator or a power line. In addition the charging stations can be used for exchanging an EMB, the power of which is depleted, with a charged EMB. This exchange can be made manually or by robot means. In some embodiments, the wheel like structure of the EMB makes the exchange easier.

The electric charging is relatively simple. It can be a stand alone unit or coupled with a mechanical energy charger. FIG. 9 is a side view of a stand alone charging unit, according to one embodiment of the invention. Basically the unit contains an electric power source 40 which can be, for example, an electric generator or a power line. The electric power source 40 is connected by an outlet cable 100 and connector 39 to the current inlet in the vehicles. Any high power rated set of connectors can be used.

“Charging” the mechanical system can be achieved by different modes. Examples are illustrated in FIGS. 8A-C and 9. Referring to FIGS. 8A-8C, an example of charging the mechanical system is the charging flywheel 34 having a high rotary energy content (large weight and large diameter) that is kept rotating by a motor 35. The motor 35 and charging flywheel 34 can be placed in an appropriate pit 41 underground while the vehicle stands on the pavement 36. The rotating axis of the charging flywheel exits from the pit and is equipped at its end with a mechanical connector 38 (FIG. 9).

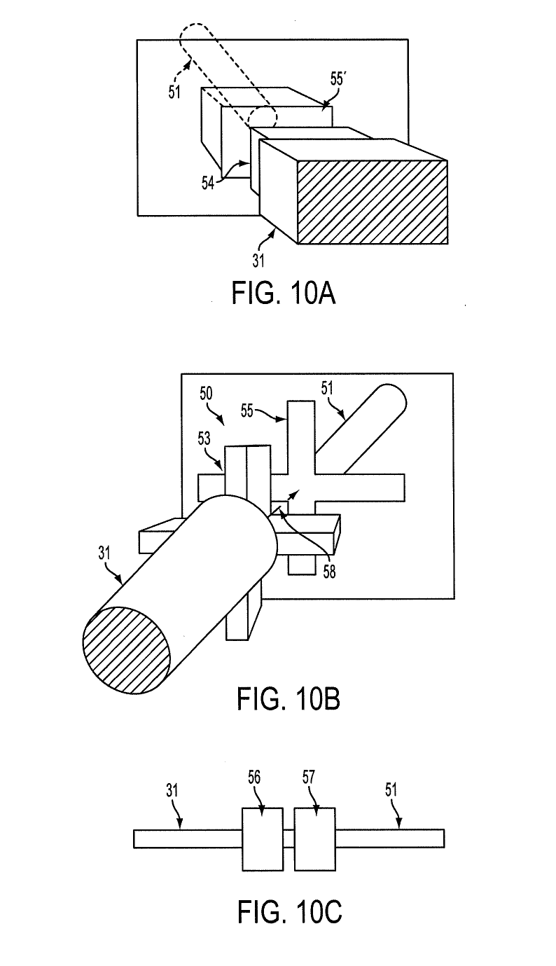

FIG. 10A is a schematic illustration of an embodiment of the invention, depicting a square-shaped mechanical connector and mechanical receptor suitable for use in a charging station. FIG. 10B is a schematic illustration of an embodiment of the invention, depicting a cross-shaped mechanical connector and mechanical receptor used in a charging station. FIG. 10C is a schematic illustration of an embodiment of the invention, depicting a coupling clutch and gears used in a charging station. The mechanical connection 38 of FIG. 9 is designed to hook onto a mechanical receptor 50 of FIG. 10 in the vehicle. In some embodiments, the cross 53 or square 54 (or similar structures) are positioned at the end of the shaft axle 31 and will fit into the corresponding recess 55 and 55′ at the tip of axle 51 so as to deliver its torque and rotate axle 51 that rotates the EMB. The direction of movements to establish connection is marked by arrow 58. The connection should be made only when the connectors are not turning one relative to the other. As the charging flywheel may rotate very rapidly while the vehicle flywheel is rotating very slowly or at a standstill, a coupling clutch 56 and gears 57 (FIG. 10C), such as those used in cars can be used. These coupling means may not necessary if the connection is made while the connector-receptor pair is stationary and rotation begins only after the connection is made. Referring to FIG. 9, such a procedure can be preferably used when the charging is made directly by a motor 37 equipped with a rotating shaft 33 and connector 38. In this case the motor and shaft rotation begin only after mechanical connection is established. As the location and/or orientation of the EMB in the vehicle may differ (see, e.g., FIGS. 8A-C), the charging rotating shafts may have different orientations 31, 33 and appropriate mechanical rotation direction changers as illustrated in FIG. 8A-C. The rotating shafts 33 may also contain an isolated electric lead 32 that can make electric contact with a corresponding lead in the vehicle.

In some embodiments, the electro-mechanical battery that includes a flywheel, for example, the flywheel 62 of FIGS. 4, 5, and 6. The flywheel includes a first rotating frame, for example, the first rotating frame 10 of FIG. 1A. The flywheel is configured to store rotational kinetic energy in the first rotating frame and facilitate retrieval of the energy. The first rotating frame can have at least one receptacle. In some embodiments the at least one receptacle is sized to fit a battery, for example battery 6 of FIG. 1A. In other embodiments, the receptacle is sized to fit multiple batteries. At least one battery, for example, battery 6 of FIG. 1A, is disposed within the at least one receptacle. The electro-mechanical battery can further include a rotating electrical connection, for example the rotating electrical connection 17 of FIG. 2A. The rotating electrical connection can permit charging of the at least one battery while the first rotating frame is rotating and to permit discharging of the at least one battery while the first rotating frame is rotating. In some embodiments, the rotating electrical connection is a mercury revolving contact.

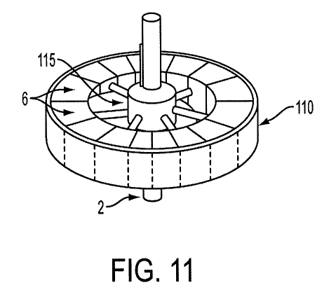

In some embodiments, the electro-mechanical battery includes a housing. FIG. 11 is a schematic illustration of an embodiment of the invention, depicting an electro-mechanical battery with a housing 110. The housing 110 can be configured to keep the flywheel in a vacuum or a partial vacuum. In some embodiments, the housing 110 can be configured to keep the first rotating frame 10 of FIG. 1A and the batteries 6 in a vacuum or a partial vacuum. The vacuum or partial vacuum can reduce the energy that lost due to friction. The housing can be an extremely strong, aerodynamic casing that reduces drag forces and can withstand centrifugal and/or hoop forces.

The main safety issue associated with an EMB, are the large forces that may forcefully eject fragments, including the potentially harmful battery constituents. The danger of this safety issue increases with the risk of vehicle accidents. Therefore, the housing or shield is preferably extremely strong. As seen in Table 2, effective shielding or encapsulation of the rotating wheel, at the rotation speeds dictated by energy considerations, in a casing constructed of the strongest current or future available materials can provide safe operation. In addition, from a safety perspective, it is preferable to use solid, relatively inert types of batteries that have both solid electrodes and electrolyte, for example, silicon nanotube batteries, all solid ceramic batteries, solid state lithium air batteries, or polymeric nanoscale all-solid state batteries. In addition, ultracapacitors can be used in place of batteries, for example, nanotube ultracapacitors.

TABLE 2

| | | | | | | FW | Shield or | hoop |
|---|---|---|---|---|---|---|---|---|
| Protector | FW | | | cylinder | | Energy | housing | stress |
| material (tensile | Mass | rₒᵤₜₑᵣ | rᵢₙₙₑᵣ | length | RPM | Stored | thickness | σ_{H} |
| strength [MPa]) | [kg] | [cm] | [cm] | [cm] | Max. | [kWh] | [cm] | [MPa] |
| Steel (2300) | 300 | 50 | 47 | 30 | 7000 | 5.3 | 2 | 2138 |
| Carbone Fiber (5650) | 300 | 50 | 47 | 30 | 11500 | 14 | 2 | 5770 |
| Carbone nanotube (11000) | 300 | 50 | 47 | 30 | 16000 | 28 | 2 | 11170 |
| Carbone nanotube (11000) | 300 | 40 | 37 | 30 | 18000 | 22 | 2 | 11310 |
| Carbone nanotube (60000) | 300 | 50 | 47 | 30 | 37000 | 147 | 2 | 59734 |
| Carbone nanotube (60000) | 300 | 40 | 37 | 30 | 42000 | 120 | 2 | 61575 |
| Carbone nanotube (60000) | 500 | 50 | 47 | 30 | 29000 | 151 | 2 | 61159 |
| Carbone nanotube (60000) | 500 | 40 | 37 | 30 | 32000 | 116 | 2 | 59574 |

Referring to FIG. 11, in some embodiments, the central part of the flywheel includes a motor or dynamo 115 that is built on the rotation axis. Rotation can be maintained by ball or magnetic bearings. The motor 115 can be designed to spin the flywheel and can be mounted on the axle 2 of the flywheel or in other suitable locations as will be known to those of skill in the art. The motor 115 can be capable of converting the spin of the flywheel into electric energy or visa versa. The motor 115 can also utilize wheel break power to charge the battery. In some embodiments, the motor and electric power generator can be integrated into one unit. Optionally, the dynamo 115 can be used to charge the batteries from the energy stored in the flywheel. This can enable electric energy storage at optimal times and cost.

In some embodiments, the electro-mechanical battery includes a second flywheel. The second flywheel can contain a frame that is configured to rotate in a direction that is opposite to a first direction of a first rotating frame (see, e.g., FIG. 7). In one embodiment, the total mass of the flywheel and the at least one battery is at least about 100 kilograms.

Another aspect of the invention relates to a vehicle. Referring to FIG. 4, the vehicle includes a chassis 101. The vehicle also includes at least two wheels, for example, wheels 102 of FIG. 4. The wheels 102 are configured with respect to the chassis 101 so that the chassis 101 rides on the at least two wheels 102. The vehicle also includes an electro-mechanical battery, for example, any one of the embodiments of the EMB described above. In some instances, the electro-mechanical battery in the vehicle includes a flywheel that has a first rotating frame. The flywheel is configured to store a rotational kinetic energy in the first rotating frame and facilitate retrieval of the energy. The rotating frame includes at least one receptacle that is capable of having a battery disposed within the receptacle. The electro-mechanical battery can also include a rotating electrical connection configured to permit charging of the battery while the first rotating frame is rotating and to permit discharging of the battery while the first rotating frame is rotating. The vehicle is configured so that the rotational kinetic energy of the first rotating frame can be used to drive the vehicle and that electrical energy from the battery can also be used to drive the vehicle.

When the electro-mechanical battery is used in a vehicle, deceleration can be accomplished at least in part by transferring kinetic energy of the vehicle into rotational kinetic energy of the first rotating frame. In addition, deceleration of the vehicle can be accomplished at least in part by transferring kinetic energy of the vehicle into electricity and using the electricity to charge the battery.

As an example, batteries weighing about 300 kg and about 500 kg can be integrated into a flywheel rotor or rotating frame. The batteries have a volume of at least 100 liters. The flywheel rotor, or rotating frame, having an outer radius of about 40 to about 50 cm. The flywheel height or thickness is large, about 30 cm. The circumference of the rotor, or rotating frame, consists of the mass of the rechargeable batteries plus the protective shield of selected materials. The ensemble is contained within a shell of an aerodynamic shape (to minimize drag) that could contain internal gas at low pressure.

Variations, modifications, and other implementations of what is described herein will occur to those of ordinary skill in the art without departing from the spirit and the scope of the invention as claimed. Accordingly, the invention is to be defined not the preceding illustrative description but instead by the spirit and scope of the following claims.

What is claimed is:

1. An electro-mechanical battery comprising:
a support member;
a first rotating frame supported by the support member and configured to rotate about an axis;
at least one battery supported by the first rotating frame;
a mechanical coupling system configured to store rotational kinetic energy in the first rotating frame and facilitate retrieval of the rotational kinetic energy; and
a rotating electrical connection between the support member and the at least one battery, wherein the rotating electrical connection is configured to permit charging of the at least one battery and discharging of the at least one battery while the first rotating frame is rotating.

2. The electro-mechanical battery of claim 1 wherein the rotating electrical connection comprises a mercury revolving contact.

3. The electro-mechanical battery of claim 1 further comprising a second rotating frame supported by the support member and configured to rotate about the axis wherein the first rotating frame is configured to rotate in a first direction and the second rotating frame is configured to rotate in a second direction that is opposite to the first direction.

4. The electro-mechanical battery of claim 1 wherein the first rotating frame is supported by the support member by at least one of a magnetic bearing or a high-temperature superconductor bearing.

5. The electro-mechanical battery of claim 1 wherein the support member is supported by at least one gimbal.

6. The electro-mechanical battery of claim 1 further comprising a housing configured to keep the first rotating frame and the at least one battery in a vacuum or a partial vacuum.

7. The electro-mechanical battery of claim 1 wherein a total mass of the first rotating frame and the at least one battery is at least 100 kilograms.

8. The electro-mechanical battery of claim 1 wherein the first rotating frame is designed to rotate at least 8,000 RPM.

9. The electro-mechanical battery of claim 1 wherein the first rotating frame is designed to rotate at least 20,000 RPM.

10. An electro-mechanical battery comprising:
a flywheel having a first rotating frame, wherein the flywheel is configured to store rotational kinetic energy in the first rotating frame and facilitate retrieval of the rotational kinetic energy, and wherein the first rotating frame has at least one receptacle;
at least one battery disposed within the at least one receptacle; and
a rotating electrical connection configured to permit charging of the at least one battery while the first rotating frame is rotating and to permit discharging of the at least one battery while the first rotating frame is rotating.

11. The electro-mechanical battery of claim 10 further comprising a housing configured to keep the flywheel in a vacuum or a partial vacuum.

12. The electro-mechanical battery of claim 10 further comprising a second flywheel, the second flywheel containing a second rotating frame, wherein the first rotating frame is configured to rotate in a first direction and the second rotating frame is configured to rotate in a second direction that is opposite to the first direction.

13. The electro-mechanical battery of claim 10 wherein a total mass of the fly wheel and the at least one battery is at least 100 kilograms.

14. The electro-mechanical battery of claim 10 wherein the rotating electrical connection comprises a mercury revolving contact.

15. A vehicle comprising:
a chassis;
at least two wheels configured with respect to the chassis so that the chassis rides on the at least two wheels; and
an electro-mechanical battery positioned in the vehicle, the electro-mechanical battery including (a) a flywheel having a first rotating frame, wherein the flywheel is configured to store a rotational kinetic energy in the first rotating frame and facilitate retrieval of the rotational kinetic energy, and wherein the first rotating frame has at least one receptacle, (b) at least one battery disposed within the at least one receptacle, and (c) a rotating electrical connection configured to permit charging of the at least one battery while the first rotating frame is rotating and to permit discharging of the at least one battery while the first rotating frame is rotating,
wherein the vehicle is configured so that rotational kinetic energy of the first rotating frame can be used to drive the vehicle and that electrical energy from the at least one battery can be used to drive the vehicle.

16. The vehicle of claim 15 wherein deceleration of the vehicle is accomplished at least in part by transferring kinetic energy of the vehicle into rotational kinetic energy of the first rotating frame.

17. The vehicle of claim 16 wherein deceleration of the vehicle is accomplished at least in part by transferring kinetic energy of the vehicle into electricity, and using said electricity to charge the battery.
